(19) United States
(12) Patent Application Publication
(10) Pub. No.: US 2007/0169098 A1
(43) Pub. Date: Jul. 19, 2007

(54) FIRMWARE UPDATING CIRCUIT AND FIRMWARE UPDATING METHOD

(75) Inventor: Yuuji Kikuchi, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 11/623,664

(22) Filed: Jan. 16, 2007

(30) Foreign Application Priority Data
Jan. 19, 2006 (JP) 2006-011461

(51) Int. Cl. G06F 9/44

(52) U.S. Cl. 717/168

(57) ABSTRACT

A firmware updating circuit of the present invention includes an identification part and an address inversion part. The identification part stores identification data corresponding to an address of a boot loader in a non-volatile memory for storing the boot loader and a main program. When the controller updates both the boot loader and the main program, the address inversion part changes an address for reading the boot loader, output by a controller to the non-volatile memory, and an address for writing another boot loader to be updated according to the identification data so that those addresses come to be different from each other and at least one of the boot loader and the boot loader to be updated comes to exist in the non-volatile memory.

### FIELD OF THE INVENTION

The present invention relates to a firmware updating circuit and a firmware updating method.

### BACKGROUND OF THE INVENTION

A firmware updating circuit is a circuit for rewriting firmware-related data stored in a flash memory on board in case where the firmware for controlling a computer device must be updated to enhance its function and avoid a problem. Conventionally, if such a trouble as power-off occurs at the time of firmware updating, the data in the flash memory is damaged and the computer device is never started up unless otherwise the flash memory is replaced. There have been proposed some means to solve such a problem.

For example, JP-A No. 78336/2005 discloses a program rewriting method for an image forming apparatus. According to this method, old data (to be updated) is saved in an FROM before the firmware is updated. And if such a trouble as power-off occurs and firmware updating fails, the saved data is restored in the memory, then the firmware is updated again. This conventional technique has a problem, however. If a trouble occurs while old data (to be updated) is being saved, the reliability of the saved data itself is lost and the FROM used for the saving is redundant, so that the updating cost increases.

JP-A No. 228225/2005 discloses a memory card adapter. This memory card adapter enables a boot part in a flash memory to be used as a non-rewriting area. This makes it possible to protect the boot part from damages even when such a trouble as power-off occurs while a program part is being rewritten, thereby the firmware can be updated again. Nevertheless, this conventional technique has a problem that the firmware designer comes to be restricted in programming, since a fixed non-rewriting area must be prepared in a flash memory. Particularly, in every firmware, the program part capacity is increased unavoidably at each time of revision-up and this is a fatal disadvantage for a system provided with less capacity firmware to realize a low manufacturing cost to have such a fixed area.

Furthermore, JP-A No. 003213/1999 discloses an information processing system. This system includes a start-up ROM separately. Thus the firmware can be started up from this start-up ROM to update the firmware even when such a trouble as power-off occurs while the flash memory is being rewritten. This conventional technique also includes some problems that the start-up ROM is redundant and the manufacturing cost increases, as well as the loader part cannot be updated, thereby the firmware function is limited.

There is also another method for doubling a flash memory itself. This method causes the flash memory to be redundant, thereby increasing the manufacturing cost.

JP-A No. 195260/2001 also discloses a related technique, that is, a boot program rewriting system. This rewriting system divides a physical area into two areas; a first area and a second area. The first area stores a boot program for setting procedures from power on to system start-up. The second area is provided with a rewritable non-volatile read only memory for storing a rewriting routine for rewriting the boot program, as well as a manual switch for inversing logically one address bit given to the rewritable non-volatile read on memory.

In this case, the flash memory must have a fixed area (for saving a rewriting routine) and this makes the firmware designer to be restricted in programming. In the case of a method for providing a plurality of rewriting routines in the second embodiment, the program memory capacity comes to be more limited. In the case of another method for inverting only the most significant bit address to write data in both upper and lower logical bits, the flash ROM is duplicated in it after all, so that the program memory capacity is limited to a half. The method cannot correspond to the capacity of an updated program. Furthermore, the method uses an external switch and this requires hands.

JP-A No. 222084/2002 discloses a semiconductor memory device. This memory device is divided into a plurality of areas. Each of the plurality of areas enables one or a plurality of small sectors to be allocated in the most significant physical address in the area or in a plurality of sequential physical addresses including the most significant physical address. This memory device may have an address translation circuit. In this case, each of the plurality of areas has a plurality of sectors, each of which is larger than the small sector, and the address translation circuit translates each of the sector addresses entered from external and makes the plurality of areas to function as the same boot block type ones.

In this case, this memory is just duplicated; the same memory has a top type bank and a bottom type bank. In such memory duplication, the flash memory part is redundant, thereby the manufacturing cost rises.

JP-A No. 255084/1996 discloses a method for upgrading an EEPROM. This upgrading method includes steps of: copying boot data in an alternate boot block related to an alternate address space from a main boot block related to a main address space in a first memory; setting a second non-volatile memory so that the alternate boot block appears in the main address space in the viewpoint of a microprocessor and the main boot block appears in the alternate address space; writing new boot data in the main boot bock; and resetting the second non-volatile memory so that the main boot block is returned to the main address space and the alternate boot block is returned to the alternative address space.

In this case, the main boot block is copied temporarily in another area as an alternate block so as to be secured from power failures after erasing/rewriting. When in rewriting a program, therefore, a special sequence is required and the rewriting time is increased by the special sequence. Furthermore, the rewriter (e.g., processor) must be given some intelligence with use of a program or the like.

JP-A No. 526828/2002 discloses a method for protecting a boot block code when enabling a write access to the boot block. This method protects a first boot block code and enables updating of another code or data resident in the same segment or area as that of the first boot block code. At that time, the first boot block and another code or data are stored in the first writable segment and the segment is set so as to be protected and not to be written in. The method comprises the steps of: a) copying all information items stored in a first writable segment to a second writable segment in a memory; b) inspecting the validity of information copied into the second writable segment in the memory; c) setting the first writable segment in a unprotected writable state; d) erasing all information items stored in the first writable segment; and e) updating the first writable segment with updated code or data. The updated code or data includes a second boot block code. The method further includes the steps of: f) comparing the second boot block code stored in the first writable segment with the first boot block code stored in the second writable segment; and g) setting the first rewritable segment in a protected writable state if it is determined in the comparison in step f) that the second and first boot block codes stored in the first and second rewritable segments are identical.

This is why there has been expected a firmware updating circuit and a firmware updating method in which firmware related data can be rewritten on board without replacing the non-volatile memory even when such a trouble as power-off occurs at the time of firmware updating. There has also been expected a firmware updating circuit or firmware updating method that requires no fixed loader area to be secured in a non-volatile memory having a program area for storing a main program and a loader area for storing a boot loader at the time of writing on board as described above, as well as that does not require the firmware designer to be conscious of the loader area at the time of firmware designing. Furthermore, there has also been expected a firmware updating circuit and a firmware updating method that does not require any redundant non-volatile memory when in rewriting as described above.

### SUMMARY OF THE INVENTION

Under such circumstances, it is an object of the present invention to provide a firmware updating circuit and a firmware updating method that are capable of rewriting firmware-related data on board without replacing any non-volatile memory even when such a trouble as power-off occurs at the time of firmware updating.

It is another object of the present invention to provide a firmware updating circuit and a firmware updating method that do not require securing of a fixed loader area for storing a boot loader in a non-volatile memory at the time of rewriting as described above.

It is still another object of the present invention to provide a firmware updating circuit and a firmware updating method that do not require any redundant non-volatile memory.

Hereunder, means for solving the above conventional problems will be described using numbers and symbols in the preferred embodiments of the present invention. The numbers and symbols are provided in parentheses respectively to identify the relationship between the description of the scope of the claims and the description of the preferred embodiments of the present invention. Those numbers and symbols cannot be used for interpreting the technical field of the present invention described in the claims.

In order to solve the above conventional problems, a firmware updating circuit of the present invention includes an identification part (5) and an address inversion part (4). The identification part (5) stores identification data (5a) corresponding to the address of a boot loader in a non-volatile memory (3) that stores the boot loader, as well as a main program. The address inversion part (4), when a controller (2) updates the boot loader and the main program, changes an address (10) for reading the boot loader, output to the non-volatile memory (3) from the controller (2), and an address (10) for writing the boot loader to be updated so that those addresses come to be different from each other, according to the identification data (5a) so that at least one of the boot loader and another boot loader to be updated comes to exist in the non-volatile memory (3).

The present invention enables a read address (10) in which an existing boot loader is stored to be different from a write address (10) in which another boot loader to be updated is to be stored. Consequently, in the non-volatile memory (3), the boot loader to be updated can be written in an area that is different from an area that stores the existing boot loader. Thus even when such a trouble as power-off occurs while the firmware (boot loader+main program) is being updated, at least one of the existing boot loader and the boot loader to be updated can remain without being overwritten in the non-volatile memory (3). That is why the firmware can be updated again without replacing the non-volatile memory (3).

In the above firmware updating circuit, the address inversion part (4) executes either inversion or non-inversion for the read address (10) according to the identification data (5a) at the time of firmware updating and executes the other for the write address (10).

Also in the above firmware updating circuit, the address inversion part (4) executes non-inversion for the read address (10) and executes the other (inversion) for the write address (10) when the identification data (5a) is in the first state (“0”).

Also in the firmware updating circuit, the address inversion part (4) executes non-inversion for the read address (10) and executes inversion for the write address (10) when the identification data (5a) is in the second state (“1”).

The above firmware updating circuit further includes a monitoring part (6) for monitoring an updating related timeout. The identification part (5), when the monitoring part (6) detects a timeout, updates the identification data (5a) having been set until the timeout is detected. Hereinafter, the address inversion part (4) executes inversion and non-inversion for the read address (10) and for the write address (10) respectively according to the updated identification data (5a).

Also in order to solve the above conventional problems, an information processing apparatus of the present invention includes a controller (2), a non-volatile memory (3) for storing a boot loader and a main program, and a firmware updating circuit (1a) according to any of the above descriptions and connected to the controller (2) and the non-volatile memory (3) communicably.

In order to solve the above conventional problems, a firmware updating method of the present invention includes the steps of: (a) changing or not changing a read address (10) for a boot loader, output from a controller (2) according to the identification data (5a) corresponding to a boot loader address in a non-volatile memory (3) so that at least one of a boot loader and another boot loader to be updated comes to exist in the non-volatile memory (3) when the controller (2) updates the boot loader and the main program stored in the non-volatile memory (3), then sending the changed/not changed address (10) to the non-volatile memory (3); and (b) executing the other of the changing/not changing for a write address (10) for the boot loader to be updated, output from the controller (2), then sending the address to the non-volatile memory 83).

In the above firmware updating method, the step (a) includes a step (a1) of executing either inversion or non-inversion for a read address (10) according to the identification data (5a) at the time of updating. The step (b) includes a step (b1) of executing the other of the inversion or non-inversion for a write address (10) according to the identification data (5a) at the time of updating.

In the above firmware updating method, the step (a1) includes a step (a11) of executing non-inversion for a read address (10) when the identification data (5a) is in the first state (“0”). The step (b1) includes a step (b11) of executing inversion for a write address (10) when the identification data (5a) is in the first state (“0”).

In the above firmware updating method, the step (a1) includes a step (a12) of executing inversion for a read address (10) when the identification data (5a) is in the second state (“1”). The step (b1) includes a step (b12) of executing non-inversion for a write address (10) when the identification data (5a) is in the second state (“1”).

In the firmware updating method, the method further includes: a step (c) of monitoring an updating related timeout at the time of updating; a step (d) of updating the identification data (5a) when a timeout is detected; and a step (e) of executing the steps (a) and (b) according to the updated identification data (5a).

According to the present invention, therefore, it is possible to update firmware related data on board without replacing any non-volatile memory even when such a trouble as power-off occurs at the time of firmware updating.

### BRIEF DESCRIPTION OF THE DRAWINGS

FIG. 1 is a block diagram of a configuration of a computer device to which a firmware updating circuit of the present invention is applied in an embodiment;

FIG. 2 is a block diagram of a configuration of an address inversion circuit in the embodiment of the firmware updating circuit of the present invention;

FIG. 3A is a truth table of the address inversion circuit in FIG. 2;

FIG. 3B is a truth table of the address inversion circuit in FIG. 2;

FIG. 4 is a flowchart of the operations in an embodiment of the computer device to which a firmware updating circuit of the present invention is applied;

FIGS. 5A and 5B are concept diagrams showing states of a flash memory in each operation;

FIGS. 6A and 6B are concept diagrams showing states of a flash memory in each operation;

FIG. 7 is a flowchart of the operations at the time of abnormality occurrence in the operations of the computer device to which a firmware updating circuit of the present invention is applied in an embodiment;

FIGS. 8A through 8C are concept diagrams showing states of a flash memory at the time of abnormality occurrence;

FIGS. 9A thorough 9C are concept diagrams showing states of a flash memory at the time of abnormality occurrence;

FIG. 10 is a timing chart of the operations of the computer device to which a firmware updating circuit of the present invention is applied in an embodiment; and

FIG. 11 is a timing chart of the operations of the computer device to which a firmware updating circuit of the present invention is applied in an embodiment.

### DETAILED DESCRIPTION OF THE PREFERRED EMBODIMENTS

Hereunder, a description will be made for a firmware updating circuit and a firmware updating method of the present invention in an embodiment with reference to the accompanying drawings.

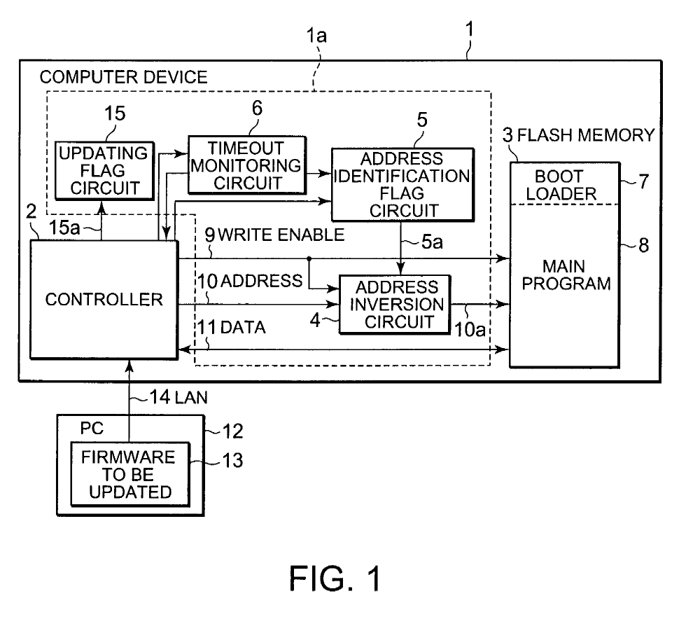

FIG. 1 is a block diagram of a configuration of a computer device to which a firmware updating circuit of the present invention is applied in an embodiment. The computer device 1 includes a controller 2, a firmware updating circuit 1a, and a flash memory 3. The firmware updating circuit 1a is connected to both the controller 2 and the flash memory 3 communicably and includes an address inversion circuit 4, an address identification flag circuit 5, a timeout monitoring circuit 6, and an updating flag circuit 15.

The computer device 1 is connected to an external PC (Personal Computer) 12 through a LAN 14. The firmware to be updated in the PC 12 is written in a flash memory 3 through the controller 2.

The controller 2 is an arithmetic operation part shown as a CPU (Central Processing Unit). The controller 2 controls the operation of each circuit in the firmware updating circuit 1a, as well as the operation of the flash memory 3. The controller 2 is connected to the flash memory 3 and outputs a write enable signal 9, an address signal 10, and a data signal 11 to the flash memory 3. And the controller 2 receives the data signal 11 from the flash memory 3.

The flash memory 3 stores the boot loader 7 and the main program 8 that are combined to compose the firmware. The flash memory 3 stores a data signal 11 in an area indicated by an address signal 10 in response to a write enable signal 9 output from the controller 2. Otherwise, the flesh memory 3 outputs the data stored in an area indicated by the address signal 10 received from the controller 2 to the controller 2 as a data signal 11. The flash memory 3 may be any of other types if it is a non-volatile one.

The address inversion circuit 4 receives a write enable signal 9, as well as an address identification flag 5a supplied from the address identification flag circuit 5. Then, the address inversion circuit 4 determines whether to send the address signal 10 as is or inverses the address signal 10 and send the inverted address signal 10 to the flash memory 3 according to those values. After that, the address inversion circuit 4 sends an address signal 10a that indicates either the address signal 10 or the inverted address signal 10 to the flash memory 3.

When writing data to the flash memory 3, the controller 2 sets 1 (High state) in the write enable signal 9, then outputs an address signal 10 and a data signal 11 to the flash memory 3. In this case, the address signal 10 indicates a write address in the flash memory 3. The data signal indicates write data to the flash memory 3. The address signal 10 is supplied to the address inversion circuit 4. The address inversion circuit 4 receives a write enable signal 9, as well as an address identification flag 5a supplied from the address identification flag circuit 5 and outputs an input address signal 10a to the flash memory 3 according to the write enable signal 9 and the identification flag 5a. The flash memory 3 stores the data signal 11 in an area in the flash memory 3, indicated by the input address signal 10a output from the address inversion circuit 4 in response to the write enable signal 9.

When reading data from the flash memory 3, the controller 2 sets “0” in a write enable signal 9 (Low state) and outputs an address signal 10 to the flash memory 3. In this case, the address signal 10 indicates a read address in the flash memory 3. The address signal 10 is then supplied to the address inversion circuit 4. The address inversion circuit 4 receives the Low state write enable signal 9, as well as an address identification flag 5a supplied from the address identification flag circuit 5 and outputs an input address signal 10a to the flash memory 3 according to the write enable signal 9 and the identification flag 5a. The flash memory 3 outputs the data signal 11 stored in an area in the flash memory 3, indicated by the input address signal 10a output from the address inversion circuit 4, in response to the Low state write enable signal 9. The data signal 11 indicates the data read from the flash memory 3.

The timeout monitoring circuit 6 is connected to both the controller 2 and the address identification flag circuit 5. The timeout monitoring circuit 6, when detecting a timeout, controls inversion of the address identification flag 5a output from the address identification flag circuit 5 and resets the controller 2. The timeout monitoring circuit 6 is composed of a counter and starts counting with a set command issued from the controller 2. Usually, in the timeout monitoring circuit 6, a value that is over a time required for firmware updating is set as a timeout. The timeout monitoring circuit 6, when detecting such a timeout, inverses the address identification flag 5a and resets the controller 2.

The updating flag circuit 15 is connected to the controller 2 and it is composed of a non-volatile register that stores an updating flag 15a. The updating flag 15a, when it is set at “1”, indicates that the firmware is being updated. At that time, if the controller 2 is reset, the controller 2 reads data from the boot loader 7 in the flash memory 3. The updating flag 15a, when it is set at “0”, indicates that the firmware is operating normally. If the controller 2 is reset at that time, the controller 2 reads the main program from the flash memory 3. This updating flag 15a may be the data in the least significant address in the flash memory 3.

The address identification flag circuit 5 is connected to both the timeout monitoring circuit 6 and the address inversion circuit 4 and it is composed of one bit of the non-volatile register that stores the address identification flag 5a. The address identification flag 5a, when its value is “1”, indicates that a read address is inverted and a write address is not inverted in the address inversion circuit 4. The address identification flag 5a, when its value is “0”, indicates that a write address is inverted and a read address is not inverted in the address inversion circuit 4.

In this embodiment, writing to the flash memory 3 is done only when the firmware is updated to simplify the description. In a general flash memory, control signals of the flash memory 3 are used as follows; a chip enable signal and a write enable signal are used to select reading and writing respectively. In this embodiment, however, writing is done at write enable=1 (High state) and reading is done at write enable=0 (Low state) to simplify the description.

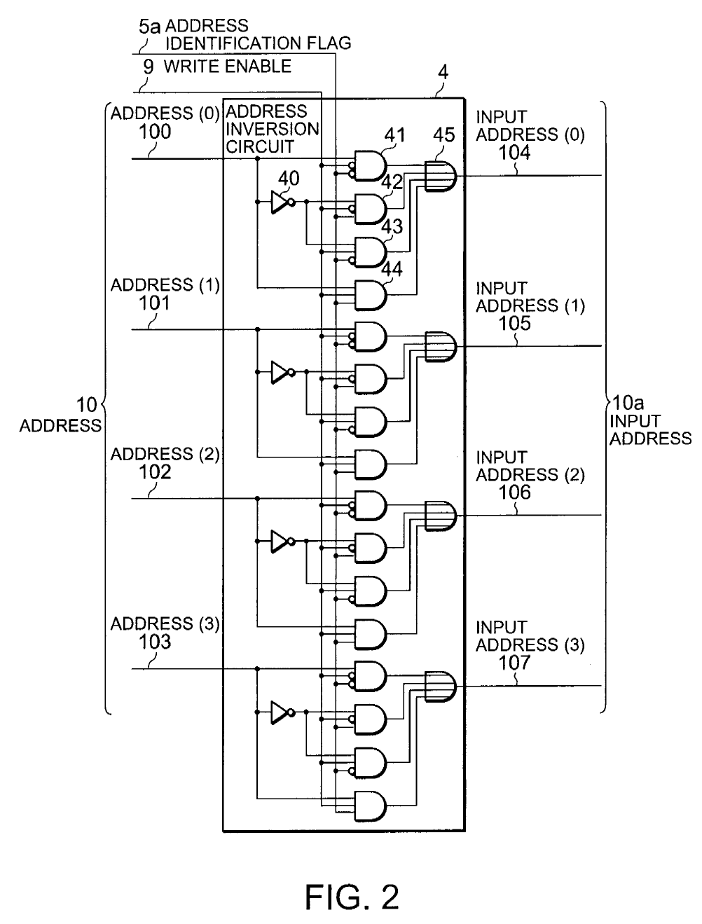

Next, the address inversion circuit 4 will be described. The address inversion circuit 4 can be realized by, for example, a combination of an inverter and a selector. FIG. 2 is a block diagram of a configuration of an address inversion circuit 4 in the embodiment of the firmware updating circuit of the present invention.

The address inversion circuit 4 includes an inverter 40, AND circuits 41 to 44, and an OR circuit 45 for each of the address signal lines. Each of the AND circuits 41 to 44 and the OR circuit 45maybe such a multiple circuit as a selector. Here, an example of the address inversion circuit 4 is shown. The address inversion circuit 4 corresponds to signal lines of 4 bits from an address signal (0) 100 to an address signal (3) 103. In other words, the address signal 10 entered to the address inverse signal 4 is composed of address signals (0) 100 to (3) 103. On the other hand, the input address signal 10a output from the address inversion circuit 4 is composed of address signals (0) 104 to (3) 107.

The number of address signal lines is not limited only to this (4); it may be more. For example, the number of address signal lines is determined by the number of address signal lines of the flash memory 3.

All the address signal lines of the address inversion circuit 4 are the same. Thus only a circuit for the address signal (0) will be described here. The inverter 40 inverts the output level of the address signal (0) 100. When the address signal (0) 100 is High, the inverter 40 outputs a Low signal. When the address signal (0) 100 is Low, the inverter 40 outputs a High signal. The AND circuit 41 outputs the value of the address signal (0) 100 when the write enable signal 9 is Low and the address identification flag Sa is Low. When the write enable signal 9 and the address identification flag 5a are not Low respectively, the AND circuit 41 outputs a Low signal. The AND circuit 42 outputs an inverted value of the value of the address signal (0) 100 when the write enable signal 9 is Low and the address identification flag 5a is High. When the write enable signal 9 and the address identification flag 5a are not as described above, the AND circuit 42 outputs a Low signal. The AND circuit 43 outputs an inverted value of the value of the address signal (0) 100 when the write enable signal 9 is High and the address identification flag 5a is Low. When the write enable signal 9 and the address identification flag 5a are not as described above, the AND circuit 43 outputs a Low signal. The AND circuit 44 outputs the value of the address signal (0) 100 when the write enable signal 9 is High and the address identification flag 5a is High. When the write enable signal 9 and the address identification flag 5a are not as described above, the AND circuit 44 outputs a Low signal. The OR circuit 45 outputs a logical sum of the outputs of the AND circuits 41 to 44 as an input address signal (0) 104. If any of the AND circuits 41 to 44 is High, the OR circuit 45 outputs a High signal. If all the circuits are High, the OR circuit 45 outputs a High signal. If all the circuits are Low, the OR circuit 45 outputs a Low signal. The address signals (1) 101 to (3) 103 are connected to each another through a circuit equivalent to the address signal (0) 100. The circuit outputs input address signals (1) 105 to (3) 107.

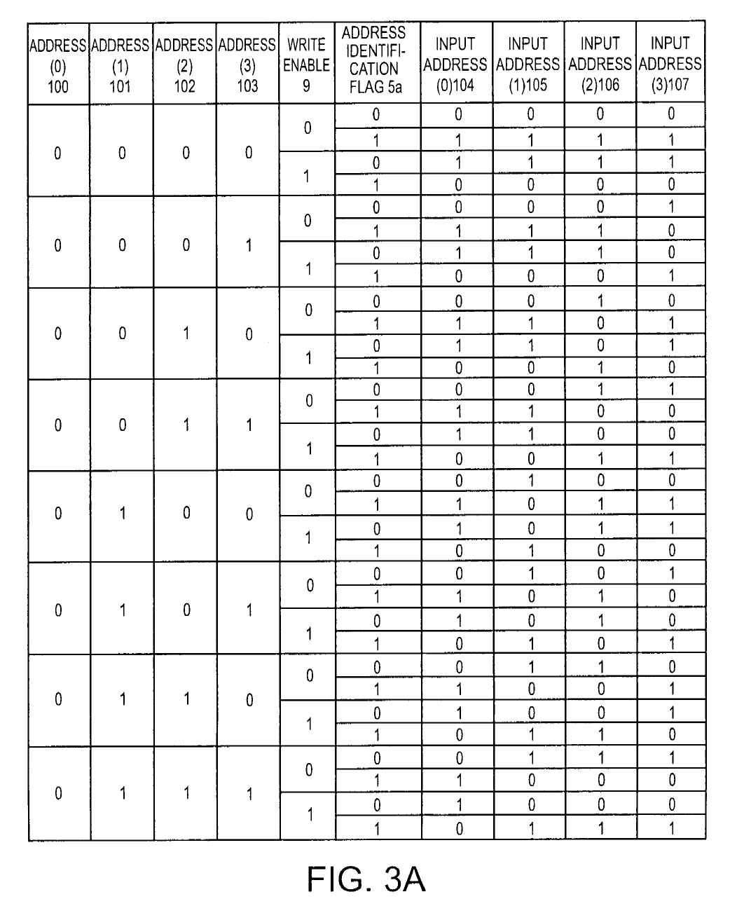

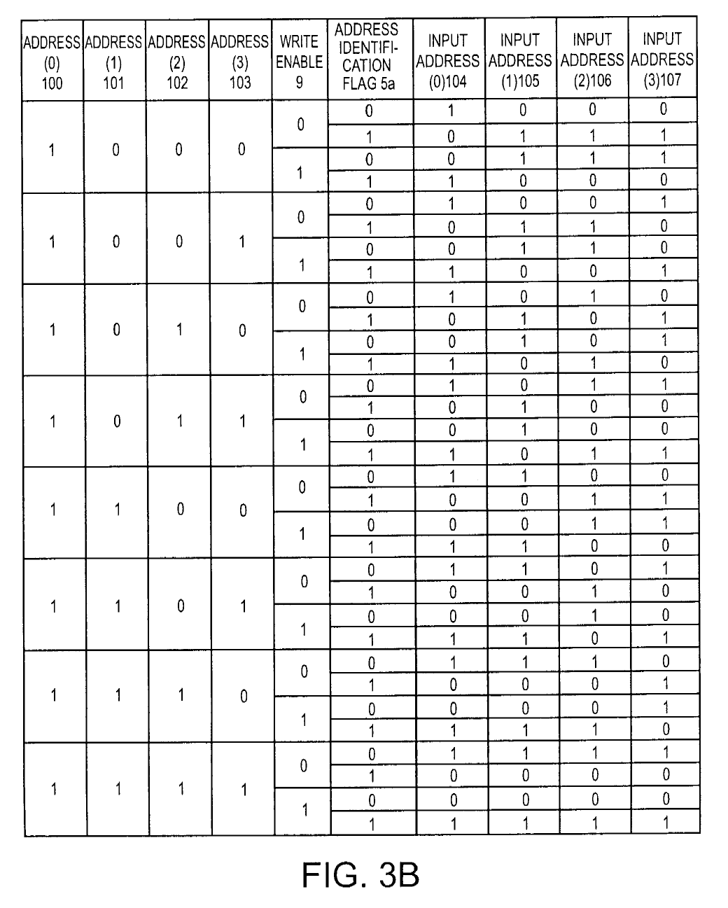

FIGS. 3A and 3B are truth tables of the address inversion circuit 4 shown in FIG. 2. The address inversion circuit 4 inputs address signals (0) 100 to (3) 103, a write enable signal 9, and an address identification flag 5a. The circuit 4 outputs corresponding signals that are address signals (0) 104, (1) 105 to (3) 107. The “0” in the truth table indicates that the signal line is Low. “1” indicates that the signal line is High.

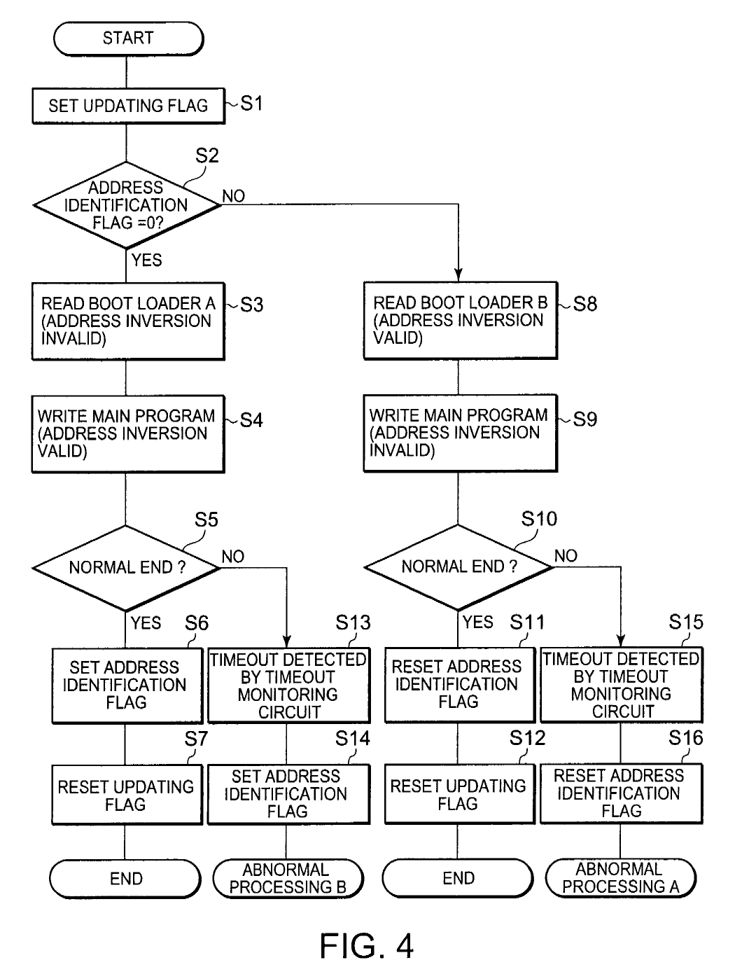

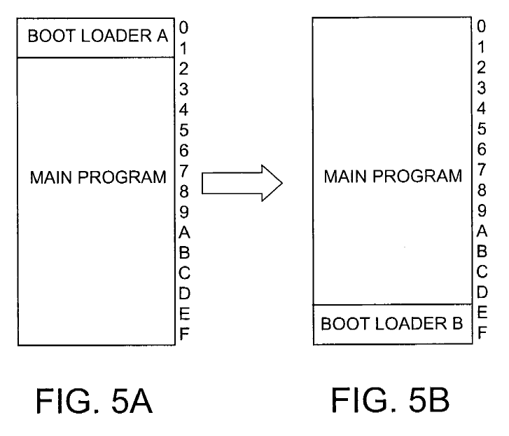

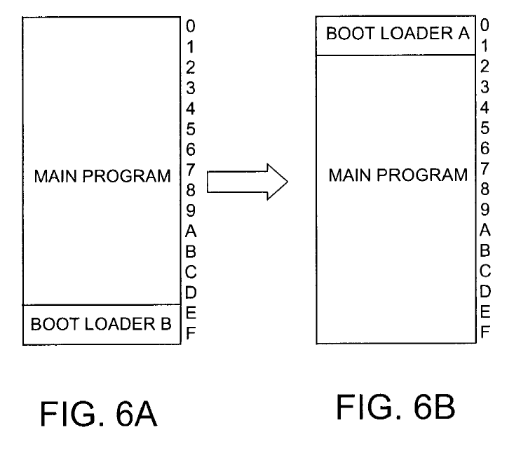

Next, a description will be made for the operations of the computer device to which a firmware updating circuit of the present invention is applied in an embodiment (embodiment for a firmware updating method of the present invention) with reference to FIGS. 4 through 6. FIG. 4 is a flowchart of the operations of the computer device to which a firmware updating circuit of the present invention is applied in an embodiment. FIGS. 5 and 6 are concept diagrams of showing a state of a flash memory 3 in each operation.

The controller 2 sets “1” for the updating flag 15a when firmware updating is started to reset itself (step S1). The controller 2, when exiting the reset operation, determines reading from the boot loader A or B according to the value of the address identification flag 5a (step S2).

In step S2, when the value of the address identification flag 5a is “0”, the controller 2 reads the boot loader A (step S03). The controller 2 outputs the address signal 10 to the flash memory 3. The address inversion circuit 4, when the value of the address identification flag 5a is “0”, does not inverse the read address signal 10 (write enable signal 9: Low) (address inversion invalid). The address inversion circuit 4 outputs the address signal 10 as is as an input address signal 10a. Consequently, the flash memory 3 outputs data from the address 0 according to the input address signal 10a. In other words, the controller 2 reads data from the address 0.

FIG. 5A shows step S3, that is, a state of the flash memory 3 before the firmware is updated. The numbers on the right vertical axis are addresses (represented in hexadecimal). Before firmware updating, the flash memory 3 stores the boot loader A in addresses 0 to 1 and the main program in addresses 2 to F respectively. The controller 2 issues a set command to the timeout monitoring circuit 6. Thus the timeout monitoring circuit 6 begins counting.

See FIG. 4. The controller 2 starts up the boot loader A and writes the main program in the flash memory 3 (step S4). The controller 2 outputs an address signal 10, a write enable signal 9, and a data signal 11 to the flash memory 3. The data signal 11 denotes the firmware 13 to be updated. The address inversion circuit 4, because the value of the address identification flag 5a is “0”, inverses the write address signal 10 (write enable signal 9: High) (address inversion valid). The address inversion circuit 4 outputs the inverted address signal 10 as an input address signal 10a. Consequently, the flash memory 3 writes the data signal 11 in and after the address F according to the input address signal 10a.

The controller 2 determines whether or not the main program writing is ended normally (step S5). If the determination result is YES (normal end) in step S5, the controller 2 sets “1” in the address identification flag 5a (step S6). After that, the controller 2 resets the updating flag 15a (step S7). The controller 2 is then reset (self-reset) and reads the main program from the new firmware and starts an ordinary processing.

FIG. 5B shows a state of the flash memory 3 when the main program writing is ended normally in step S4. The number on the right vertical axis are addresses (represented in hexadecimal). After the normal end of the main program writing, the flash memory 3 stores the boot loader B in the addresses F to E and the main program in the addresses D to 0 respectively. After exiting the processing in step S7, the controller 2 reads the main program from the addresses D to 0 of the new firmware.

In step S2, if the value of the address identification flag 5a is “1”, the controller 2 reads the boot loader B (step S8). The controller 2 then outputs an address signal 10 to the flash memory 3. The address inversion circuit 4, because the value of the address identification flag 5a is “1”, inverses the read address signal 10 (write enable signal 9: Low) (address inversion valid). The address inversion circuit 4 outputs the inverted address signal 10 as an input address signal 10a. Consequently, the flash memory 3 outputs data from the address F according to the input address signal 10a. In other words, the controller 2 reads data from the address F.

FIG. 6A shows step S8, that is, a state of the flash memory 3 before the firmware is updated. The numbers on the right vertical axis are addresses (represented in hexadecimal). Before firmware updating, the flash memory 3 stores the boot loader B in addresses F to E and the main program in addresses D to 0 respectively. In step S8, the controller 2 reads the boot loader B from the addresses F to E. At the same time, the controller 2 issues a set command to the timeout monitoring circuit 6. The timeout monitoring circuit 6 then begins counting.

See FIG. 4. The controller 2 starts up the boot loader B and writes the main program in the flash memory 3 (step S9) The controller 2 outputs an address signal 10, a write enable signal 9, and a data signal 11 to the flash memory 3. The data signal 11 denotes the firmware 13 to be updated. The address inversion circuit 4, because the value of the address identification flag 5a is “1”, does not inverse the write address signal 10 (write enable signal 9: High)(address inversion invalid). Thus the address inversion circuit 4 outputs the address signal 10 as is as an input address signal 10a. Consequently, the flash memory 3 writes the data signal 11 in and after the address 0 according to the input address signal 10a.

The controller 2 determines whether or not the main program writing is ended normally (step S10). If the determination result is YES (normal end) in step S10, the controller 2 resets the value of the address identification flag 5a to “0” (step S11). After that, the controller 2 resets the updating flag 15a (step S12). The controller 2 is then reset (self-reset) and reads the main program from the new firmware and starts an ordinary processing.

FIG. 6B shows a state of the flash memory 3 when the main program writing is ended normally in step S9. The number on the right vertical axis are addresses (represented in hexadecimal). After the normal end of the main program writing, the flash memory 3 stores the boot loader B in the addresses 0 to 1 and the main program in the addresses 2 to F respectively. After exiting the processing in step S12, the controller 2 reads the main program from the addresses 2 to F of the new firmware.

Such way, each time the firmware is updated, the value of the address identification flag 5a is changed from “0” to “1” or from “1” to “0”. In other words, if the boot loader A is valid, the new firmware is written in and after the address F at the opposite side of the valid boot loader. If the boot loader B is valid, the new firmware is written in and after the address 0 at the opposite side of the valid boot loader.

See FIG. 4 again. In step S5, if the timeout monitoring circuit 6 detects a timeout (step S13), the controller 2 determines the state as abnormal end (step S5: NO). In this embodiment, before the timeout monitoring circuit 6 detects a timeout, the counter is reset by a reset command issued from the controller 2. Thus, the controller 2 determines the state as a normal end. In this case, however, it is also possible that a check sum correlation is done in the flash memory 3 to determine such a normal end. If the timeout monitoring circuit 6 detects a timeout, the timeout monitoring circuit 6 inverses the value of the address identification flag 5a to “1” (step S14), then executes an abnormal processing B to be described later.

In step S10, if the timeout monitoring circuit 6 detects a timeout (step S15), the controller 2 determines the state as an abnormal end (step S15). If the timeout monitoring circuit 6 detects a timeout, the timeout monitoring circuit 6 inverses the value of the address identification flag 5a to “0” (step S16), then executes an abnormal processing A to be described later.

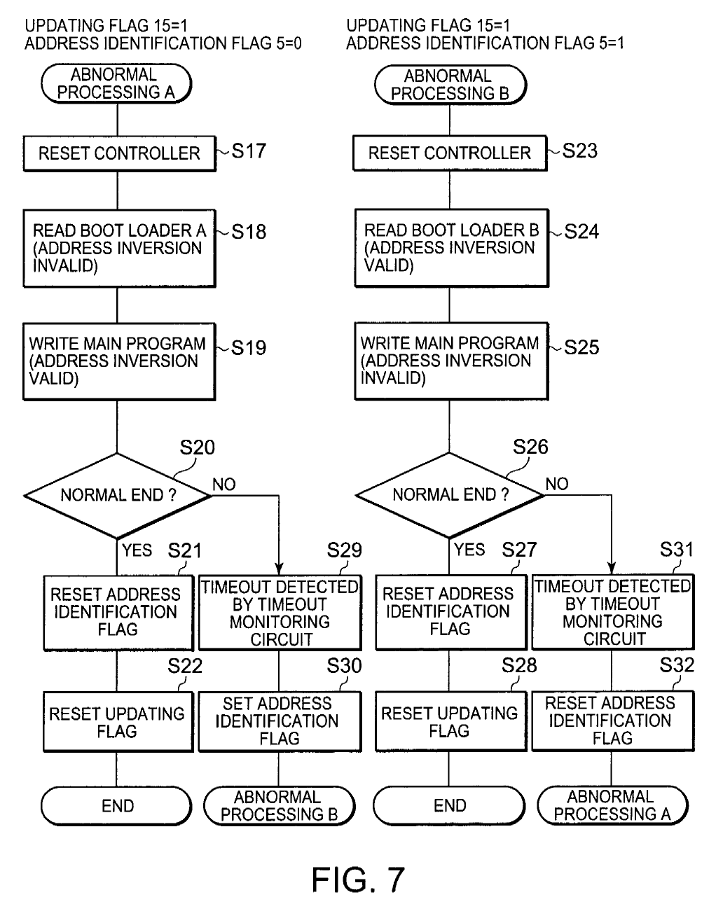

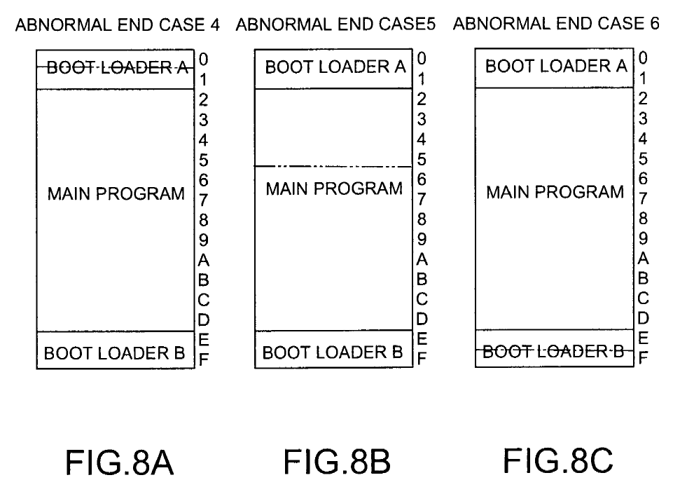

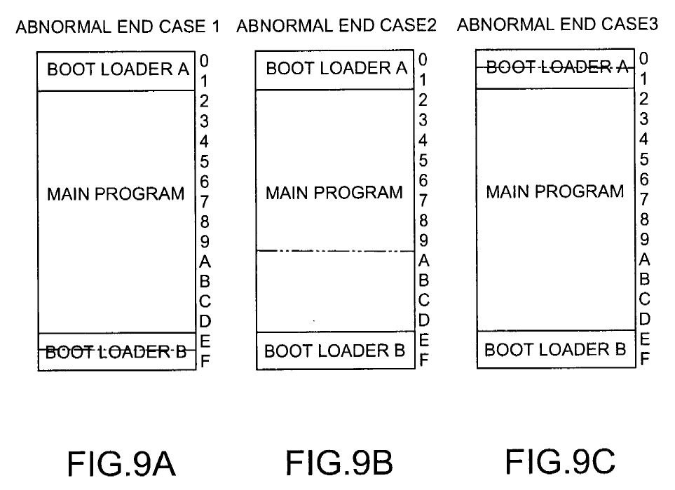

Next, a description will be made for the operations of the computer device to which a firmware updating circuit of the present invention is applied in an embodiment (for a firmware updating method of the present invention). FIG. 7 is a flow chart of the operations of the computer device to which a firmware updating circuit of the present invention is applied, at the time of abnormality occurrence in an embodiment. FIGS. 8 and 9 are concept diagrams of showing a state of a flash memory 3 at the time of abnormality occurrence.

In an abnormal processing A, because the firmware is being updated, the value of the updating flag 15a is “1” and the value of the address identification flag 5a is “0”. Assume now that such a trouble as power-off, network error, or the like has occurred while the firmware is being updated, thereby the firmware updating has been stopped halfway. FIGS. 8A through 8C show states of the flash memory 3 in such cases.

FIGS. 8A through C show an abnormal end case 4, an abnormal end case 5, and an abnormal case 6 respectively. The abnormal end case 4 is a case in which an error has occurred in the initial stage of writing. Unlike the normal end case shown in FIG. 6B, the writing of the boot loader A is stopped halfway. The abnormal end case 5 is a case in which an error has occurred in the intermediate stage of writing. Unlike the processing shown in FIG. 6B, writing of the boot loader A is completed and the main program writing is stopped halfway. The abnormal end case 6 is a case in which an error has occurred in the last stage of writing. Unlike the processing shown in FIG. 6B, writing of the boot loader A is completed while writing of the main program, as well as writing of the boot loader B are not completed respectively. The abnormal end case 4 is a case in which only the boot loader B is valid. The abnormal end case 5 is a case in which both the boot loader A and the boot loader B are valid. The abnormal end case 6 is a case in which only the boot loader A is valid.

See FIG. 7. In an abnormal end processing A, the timeout monitoring circuit 6 resets the controller 2 (step S17). The controller 2, when the resetting is canceled and the value of the address identification flag 5a is “0”, reads the boot loader A (step S18). The controller 2 outputs an address signal 10 to the flash memory 3. Because the value of the address identification flag 5a is “0”, the address inversion circuit 4 does not inverse the read address signal (write enable signal 9: Low) (address inversion invalid). The address inversion circuit 4 thus outputs the address signal 10 as is as an input address signal 10a. Consequently, the flash memory 3 outputs data from the address 0 according to the input address signal 10a. In other words, the controller 2 reads data from the address 0. At the same time, the controller 2 issues a set command to the timeout monitoring circuit 6. The timeout monitoring circuit 6 thus begins counting.

The controller 2 starts up the boot loader A and writes the main program in the flash memory 3 (step S19). Thus the address inversion is validated and the controller 2 writes data in and after the address F. The controller 2 then outputs an address signal 10, a write enable signal 9, and a data signal 11 to the flash memory 3. The data signal 11 denotes the firmware 13 to be updated. The address inversion circuit 4, because the value of the address identification flag 5a is “0”, inverses the write address signal (write enable signal 9: High) (address inversion valid). Thus the address inversion circuit 4 outputs the inversed address signal 10 as an input address signal 10a. Consequently, the flash memory 3 writes the data signal in and after the address F according to the input address signal 10a.

The controller 2 then determines whether or not the main program writing is ended normally (step S20). If the determination result is YES (normal end) in step S20, the controller 2 resets the updating flag 15a (step S22). The controller 2 is then reset (self-reset) to read the main program of the new firmware and start an ordinary processing.

On the other hand, in the abnormal processing B, the firmware is being updated and the value of the updating flag 1Sa is “1” and the value of the address identification flag 5a is “1”. Assume now that such a trouble as power-off, network error, or the like has occurred while the firmware is updated and the firmware writing is stopped halfway. FIGS. 9A through 9C show such states of the flash memory 3.

FIGS. 9A through 9C show an abnormal end case 1, an abnormal end case 2, and an abnormal end case 3, respectively. The abnormal end case 1 is a case in which an error has occurred in the initial stage of writing. Unlike the case shown in FIG. 5B (normal end case), writing of the boot loader B is stopped halfway. The abnormal end case 2 is a case in which an error has occurred in the intermediate stage of writing. Unlike the case shown in FIG. 5B, writing of the boot loader B is completed and writing of the main program is stopped halfway. The abnormal end case 3 is a case in which an error has occurred in the last stage of writing. Unlike the case shown in FIG. 5B, writing of the boot loader B is completed, but writing of the main program and writing of the boot loader A are stopped halfway respectively. The abnormal end case 1 is a case in which only the boot loader A is valid. The abnormal end case 2 is a case in which both the boot loaders A and B are valid. The abnormal end case 3 is a case in which only the boot loader B is valid.

See FIG. 7. In an abnormal end processing B, the timeout monitoring circuit 6 resets the controller 2 (step S23). The controller 2, when the resetting is canceled and the value of the address identification flag 5a is “1”, reads the boot loader B (step S24). The controller 2 outputs an address signal 10 to the flash memory 3. Because the value of the address identification flag 5a is “1”, the address inversion circuit 4 inverses the read address signal 10 (write enable signal 9: Low) (address inversion valid). The address inversion circuit 4 then outputs the inverted address signal 10 as an input address signal 10a. Consequently, the flash memory 3 outputs data from the address F according to the input address signal 10a. In other words, the controller 2 reads data from the address F. At the same time, the controller 2 issues a set command to the timeout monitoring circuit 6. The timeout monitoring circuit 6 thus begins counting.

The controller 2 starts up the boot loader B and writes the main program in the flash memory 3 (step S25). The controller 2 then outputs an address signal 10, a write enable signal 9, and a data signal 11 to the flash memory 3. The data signal 11 denotes the firmware 13 to be updated. The address inversion circuit 4, because the value of the address identification flag 5a is “1”, does not inverse the write address signal 10 (write enable signal 9: High) (address inversion invalid). The address inversion circuit 4 thus outputs the address signal 10 as is as an input address signal 10a. Consequently, the flash memory 3 writes the data signal 11 in and after the address 0 according to the input address signal 10a.

The controller 2 determines whether or not the main program writing is ended normally (step S26). If the determination result is YES (normal end) in step S26, the controller 2 resets the value of the address identification flag 5a to “0” (step S27). The controller 2 is then reset (self-reset) to read the main program of the new firm ware and start an ordinary processing.

Because the boot loader B is invalid in the abnormal end case 1, reading of the boot loader B comes to fail even when the abnormal processing B starts (step S26: NO). At this time, the timeout monitoring circuit 6 detects a timeout again (step S31) and inverses the address identification flag 5a again (step S32). After that, the controller 2 executes the abnormal processing A (steps S17 to S22).

In the same way, because the boot loader A is invalid in the abnormal processing case 4, the controller 2 fails in reading of the boot loader A even when the abnormal processing A starts (step S20: NO). At that time, the timeout monitoring circuit 6 detects a timeout again (step S29) and inverses the address identification flag 5a (step S30). After that, the controller 2 executes the abnormal processing B (steps S23 to S28).

When a timeout is detected (abnormal processing case), the controller 2 inverses the address identification flag 5a and executes the abnormal processing A and the abnormal processing B alternately. This is because it is not known which of the boot loader A and B is valid in any abnormal end case as shown in FIGS.8 and 9.

In this embodiment, firmware updating is repeated until it is ended normally. However, it is also possible to count the number of detected timeouts in the timeout monitoring circuit 6 and determine the state as a defect of the flesh memory 3 itself if the count reaches a freely preset value, thereby ending the subject firmware updating forcibly.

According to the present invention, therefore, firmware updating is completed by executing the abnormal processing A and the abnormal processing B alternately. Consequently, even when such a trouble as power-off occurs during firmware updating, the firmware related data can be rewritten on board without replacing any flash memory (non-volatile memory). Furthermore, the rewriting can be executed on board without securing any fixed loader area for storing the boot loaders (A and B) in the flash memory. And the rewriting can be executed without using any redundant flash memory (non-volatile memory).

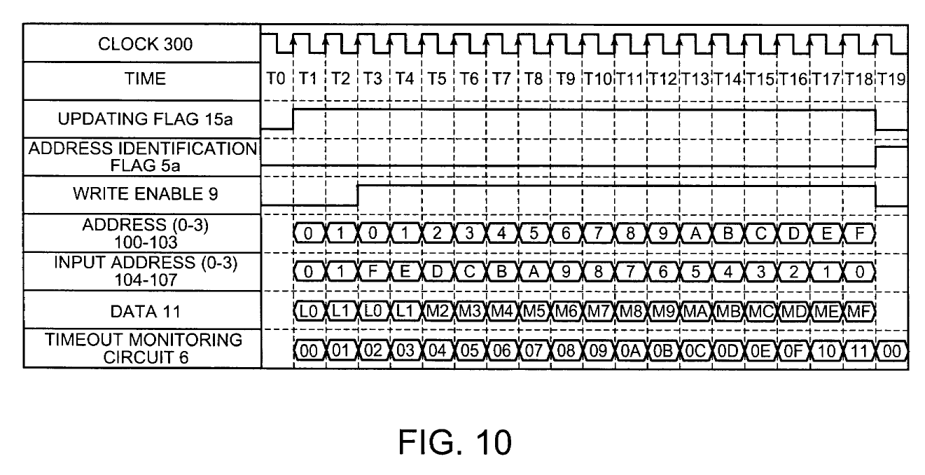

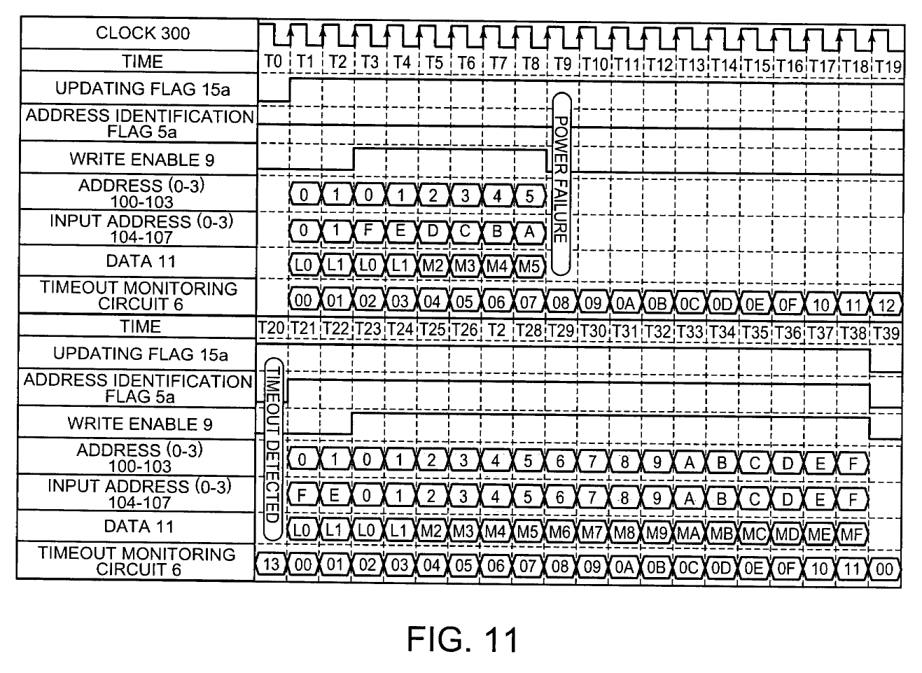

Next, a description will be made for the operations of the computer device to which a firmware updating circuit of the present invention is applied, in an embodiment (for a firmware updating method of the present invention) with reference to FIGS.10 and 11. FIGS. 10 and 11 are timing charts of the operations of the computer device to which a firmware updating circuit of the present invention is applied in an embodiment. FIG. 10 shows a case in which the operation is executed normally. FIG. 11 shows a case in which an abnormal end case 2 has occurred.

### (A) A Case in Which Firmware Updating is Done Normally

See FIG. 10. A clock 300 shows a clock signal used in a computer device 1. The time T denotes a time to be elapsed in the description of this embodiment. The time T increases by 1 at each clock of the clock 300.

At T0, firmware updating is started. The controller 2 issues a set command to the updating flag circuit 15.

At T1, the updating flag 15a is set to 1 (step Si). The controller 2 issues address signals 10 (address (0) 100 to address (3) 103)=0 (represented in hexadecimal: HEX). Because the value of the address identification flag 5a is “0” (step S2: YES), the address inversion circuit 4 outputs the address signals 10 to the flash memory 3 as input address signals 10a (address (0) 104 to address (3) 107)=0(HEX). Consequently, the controller 2 reads data L0 from address 0 in the flash memory 3 as a data signal 11. The timeout monitoring circuit 6 then begins counting.

At T2, the controller 2 issues address signals 10 (address (0) 100 to address (3) 103)=1(HEX). Because the value of the address identification flag 5a is “0”, the address inversion circuit 4 outputs the input address signals 10a (address (0) 104 to address (3) 107)=1(HEX) to the flash memory 3. Consequently, the controller 2 reads data L1 from address 1 in the flash memory 3 as a data signal 11. Thus the counter value of the timeout monitoring circuit 6 becomes “01”. Reading of the boot loader A is thus completed (step S3).

At T3, the controller 2 outputs a write enable signal 9 and a data signal 11 to the flash memory 3. At the same time, the controller 2 issues address signals 10 (address (0) 100 to address (3) 103)=0(HEX). The address inversion circuit 4, because the value of the address identification flag 5a is “0”, inverses the address signals 10 and outputs the inverted input address signals 10a (address (0) 104 to address (3) 107=F(HEX) to the flash memory 3. Consequently, the controller 2 writes data LO indicated by the data signal in the address F in the flash memory 3. Thus the counter value of the timeout monitoring circuit 6 becomes “02”.

At T4, the controller 2 outputs a write enable signal 9 and a data signal 11 to the flash memory 3. At the same time, the controller 2 issues address signals 10 (address (0) 100 to address (3) 103)=1(HEX). The address inversion circuit 4, because the value of the address identification flag 5a is “0”, outputs input address signals 10a (address (0) 104 to address (3) 107=E(HEX) to the flash memory 3. Consequently, the controller 2 writes data L1 indicated by the data signal 11 in the address E in the flash memory 3. Thus the counter value of the timeout monitoring circuit 6 becomes “03”.

At T5, the controller 2 outputs a write enable signal 9 and a data signal 11 to the flash memory 3. At the same time, the controller 2 issues address signals 10 (address (0) 100 to address (3) 103)=2(HEX). The address inversion circuit 4, because the value of the address identification flag Sa is “0”, outputs input address signals 10a (address (0) 104 to address (3) 107=D(HEX) to the flash memory 3. Consequently, the controller 2 writes data M2 indicated by the data signal 11 in the address D in the flash memory 3. Thus the counter value of the timeout monitoring circuit 6 becomes “04”.

At T6, the controller 2 outputs a write enable signal 9 and a data signal 11 to the flash memory 3. At the same time, the controller 2 issues address signals 10 (address (0) 100 to address (3) 103)=3(HEX). The address inversion circuit 4, because the value of the address identification flag 5a is “0”, outputs input address signals 10a (address (0) 104 to address (3) 107=C(HEX) to the flash memory 3. Consequently, the controller 2 writes data M3 indicated by the data signal 11 in the address C in the flash memory 3. Thus the counter value of the timeout monitoring circuit 6 becomes “05”.

At T7, the controller 2 outputs a write enable signal 9 and a data signal 11 to the flash memory 3. At the same time, the controller 2 issues address signals 10 (address (0) 100 to address (3) 103)=4(HEX). The address inversion circuit 4, because the value of the address identification flag 5a is “0”, outputs input address signals 10a (address (0) 104 to address (3) 107=B(HEX) to the flash memory 3. Consequently, the controller 2 writes data M4 indicated by the data signal 11 in the address B in the flash memory 3. Thus the counter value of the timeout monitoring circuit 6 becomes “06”.

At T8, the controller 2 outputs a write enable signal 9 and a data signal 11 to the flash memory 3. At the same time, the controller 2 issues address signals 10 (address (0) 100 to address (3) 103)=5(HEX). The address inversion circuit 4, because the value of the address identification flag 5a is “0”, outputs input address signals 10a (address (0) 104 to address (3) 107=A(HEX) to the flash memory 3. Consequently, the controller 2 writes data MS indicated by the data signal 11 in the address A in the flash memory 3. Thus the counter value of the timeout monitoring circuit 6 becomes “07”.

At T9, the controller 2 outputs a write enable signal 9 and a data signal 11 to the flash memory 3. At the same time, the controller 2 issues address signals 10 (address (0) 100 to address (3) 103)=6(HEX). The address inversion circuit 4, because the value of the address identification flag 5a is “0”, outputs input address signals 10a (address (0) 104 to address (3) 107=9(HEX) to the flash memory 3. Consequently, the controller 2 writes data M6 indicated by the data signal 11 in the address 9 in the flash memory 3. Thus the counter value of the timeout monitoring circuit 6 becomes “08”.

At T10, the controller 2 outputs a write enable signal 9 and a data signal 11 to the flash memory 3. At the same time, the controller 2 issues address signals 10 (address (0) 100 to address (3) 103)=7(HEX). The address inversion circuit 4, because the value of the address identification flag 5a is “0”, outputs input address signals 10a (address (0) 104 to address (3) 107=8(HEX) to the flash memory 3. Consequently, the controller 2 writes data M7 indicated by the data signal 11 in the address 8 in the flash memory 3. Thus the counter value of the timeout monitoring circuit 6 becomes “09”.

At T11, the controller 2 outputs a write enable signal 9 and a data signal 11 to the flash memory 3. At the same time, the controller 2 issues address signals 10 (address (0) 100 to address (3) 103)=8(HEX). The address inversion circuit 4, because the value of the address identification flag 5a is “0”, outputs input address signals 10a (address (0) 104 to address (3) 107=7(HEX) to the flash memory 3. Consequently, the controller 2 writes data M8 indicated by the data signal 11 in the address 7 in the flash memory 3. Thus the counter value of the timeout monitoring circuit 6 becomes “09”.

At T12, the controller 2 outputs a write enable signal 9 and a data signal 11 to the flash memory 3. At the same time, the controller 2 issues address signals 10 (address (0) 100 to address (3) 103)=9(HEX). The address inversion circuit 4, because the value of the address identification flag 5a is “C”, outputs input address signals 10a (address (0) 104 to address (3) 107=6(HEX) to the flash memory 3. Consequently, the controller 2 writes data M9 indicated by the data signal 11 in the address 6 in the flash memory 3. Thus the counter value of the timeout monitoring circuit 6 becomes “0B”.

At T13, the controller 2 outputs a write enable signal 9 and a data signal 11 to the flash memory 3. At the same time, the controller 2 issues address signals 10 (address (0) 100 to address (3) 103)=A(HEX). The address inversion circuit 4, because the value of the address identification flag 5a is “0”, outputs input address signals 10a (address (0) 104 to address (3) 107=5(HEX) to the flash memory 3. Consequently, the controller 2 writes data MA indicated by the data signal 11 in the address 5 in the flash memory 3. Thus the counter value of the timeout monitoring circuit 6 becomes “0C”.

At T14, the controller 2 outputs a write enable signal 9 and a data signal 11 to the flash memory 3. At the same time, the controller 2 issues address signals 10 (address (0) 100 to address (3) 103)=B(HEX). The address inversion circuit 4, because the value of the address identification flag 5a is “0”, outputs input address signals 10a (address (0) 104 to address (3) 107=4(HEX) to the flash memory 3. Consequently, the controller 2 writes data MB indicated by the data signal 11 in the address 4 in the flash memory 3. Thus the counter value of the timeout monitoring circuit 6 becomes “0D”.

At 15, the controller 2 outputs a write enable signal 9 and a data signal 11 to the flash memory 3. At the same time, the controller 2 issues address signals 10 (address (0) 100 to address (3) 103)=C(HEX). The address inversion circuit 4, because the value of the address identification flag 5a is “0”, outputs input address signals 10a (address (0) 104 to address (3) 107=3(HEX) to the flash memory 3. Consequently, the controller 2 writes data MC indicated by the data signal 11 in the address 3 in the flash memory 3. Thus the counter value of the timeout monitoring circuit 6 becomes “0E”.

At T16, the controller 2 outputs a write enable signal 9 and a data signal 11 to the flash memory 3. At the same time, the controller 2 issues address signals 10 (address (0) 100 to address (3) 103)=D(HEX). The address inversion circuit 4, because the value of the address identification flag 5a is “0”, outputs input address signals 10a (address (0) 104 to address (3) 107=2(HEX) to the flash memory 3. Consequently, the controller 2 writes data MD indicated by the data signal 11 in the address 2 in the flash memory 3. Thus the counter value of the timeout monitoring circuit 6 becomes “0F”.

At T17, the controller 2 outputs a write enable signal 9 and a data signal 11 to the flash memory 3. At the same time, the controller 2 issues address signals 10 (address (0) 100 to address (3) 103)=E(HEX). The address inversion circuit 4, because the value of the address identification flag 5a is “0”, outputs input address signals 10a (address (0) 104 to address (3) 107=1(HEX) to the flash memory 3. Consequently, the controller 2 writes data ME indicated by the data signal 11 in the address 1 in the flash memory 3. Thus the counter value of the timeout monitoring circuit 6 becomes “10”.

At T18, the controller 2 outputs a write enable signal 9 and a data signal 11 to the flash memory 3. At the same time, the controller 2 issues address signals 10 (address (0) 100 to address (3) 103)=F(HEX). The address inversion circuit 4, because the value of the address identification flag 5a is “0”, outputs input address signals 10a (address (0) 104 to address (3) 107=0(HEX) to the flash memory 3. Consequently, the controller 2 writes data MF indicated by the data signal 11 in the address 1 in the flash memory 3. Thus the counter value of the timeout monitoring circuit 6 becomes “11”. Writing of all the data is thus completed (step S04).

Upon completion of the writing, the controller 2 issues a set command to the address identification flag circuit 5. The controller 2 then issues a reset command to the updating flag circuit 15. The controller 2 then issues a reset command to the timeout monitoring circuit 6.

At T19, the address identification flag Sa is set to “1” (step S6). Then, the updating flag 15a is reset (step S07) After that, the timeout monitoring circuit 6 is reset to “00”. The controller 2 is then reset (self-reset) Because the value of the updating flag 15a is “0” at this time, the controller 2 reads the main program of the new firmware and starts an ordinary processing.

### (B) A Case in which an Abnormal End Case 2 has Occurred During Firmware Updating

See FIG. 11. The clock 300 denotes a clock signal in the computer device 1. The time T denotes a time elapsed for the description of this embodiment. The T value is increased by one at each clock of the clock 300. T0 to T8 are the same as those in FIG. 10 for normal ending, so that the description for them will be omitted here.

At T9, a power failure occurs. The timeout monitoring circuit 6 operates with a power supply different from the power failure occurred one, so that the counting is continued even after the power failure occurrence. Thus the counter value of the timeout monitoring circuit 6 becomes “08”.

At T10, T11, T12, T13, T14, T15, T16, T17, T18, and T19, the counter value of the timeout monitoring circuit 6 becomes “09”, “0A”, “0B”, “0C”, “0D”, “0E, “0F”, “10”, “11”, and “12” respectively.

At T20, the counter value of the timeout monitoring circuit 6 becomes “13” and a timeout is detected (step S5: NO, step S13). In this embodiment, the processing is ended normally when the counter value of the timeout monitoring circuit 6 is “11”. Thus the counter value over the “13” is determined as a timeout. The timeout monitoring circuit 6 thus issues a set command to the address identification flag circuit 5. The address identification flag circuit 5 sets “1” in the address identification flag 5a (step S14). Then the timeout monitoring circuit 6 issues a reset command to the controller 2. The controller 2 is thus reset (self-reset) (step S23).

At T21, the controller 2 issues address signals 10 (address (0) 100 to address (3) 103)=0(HEX). Because the value of the address identification flag 5a is “1”, the address inversion circuit 4 inverses the address signals 10 and outputs the inverted address signals 10a (address (0) 104 to address (3) 107)=F(HEX) to the flash memory 3. Consequently, the controller 2 reads data LO as a data signal 11 from the address F in the flash memory 3. And the timeout monitoring circuit 6 begins counting.

At T22, the controller 2 issues address signals 10 (address (0) 100 to address (3) 103)=1(HEX). Because the value of the address identification flag 5a is “1”, the address inversion circuit 4 outputs input address signals 10a (address (0) 104 to address (3) 107)=E(HEX) to the flash memory 3. Consequently, the controller 2 reads the data L1 as a data signal 11 from the address E in the flash memory 3. The counter value of the timeout monitoring circuit 6 becomes “01”. Reading of the boot loader B is thus completed (step S24).

At T23, the controller 2 outputs a write enable signal 9 and a data signal 11 to the flash memory 3. At the same time, the controller 2 issues address signals 10 (address (0) 100 to address (3) 103)=0(HEX). Because the value of the address identification flag 5a is “1”, the address inversion circuit 4 outputs the address signals 10 as are as input address signals 10a (address (0) 104 to address (3) 107)=0(HEX) to the flash memory 3. Consequently, the controller 2 writes the data LO indicated by the data signal 11 in the address 0 in the flash memory 3. The counter value of the timeout monitoring circuit 6 thus becomes “02”.

At T24, the controller 2 outputs a write enable signal 9 and a data signal 11 to the flash memory 3. At the same time, the controller 2 issues address signals 10 (address (0) 100 to address (3) 103)=1(HEX). Because the value of the address identification flag 5a is “1”, the address inversion circuit 4 outputs input address signals 10a (address (0) 104 to address (3) 107)=1(HEX) to the flash memory 3. Consequently, the controller 2 writes the data L1 indicated by the data signal 11 in the address 1 in the flash memory 3. The counter value of the timeout monitoring circuit 6 thus becomes “03”.

At T25, the controller 2 outputs a write enable signal 9 and a data signal 11 to the flash memory 3. At the same time, the controller 2 issues address signals 10 (address (0) 100 to address (3) 103)=2(HEX). Because the value of the address identification flag 5a is “1”, the address inversion circuit 4 outputs input address signals 10a (address (0) 104 to address (3) 107)=2(HEX) to the flash memory 3. Consequently, the controller 2 writes the data M2 indicated by the data signal 11 in the address 2 in the flash memory 3. The counter value of the timeout monitoring circuit 6 thus becomes “04”.

At T26, the controller 2 outputs a write enable signal 9 and a data signal 11 to the flash memory 3. At the same time, the controller 2 issues address signals 10 (address (0) 100 to address (3) 103)=3(HEX). Because the value of the address identification flag 5a is “1”, the address inversion circuit 4 outputs input address signals 10a (address (0) 104 to address (3) 107)=3(HEX) to the flash memory 3. Consequently, the controller 2 writes the data M3 indicated by the data signal 11 in the address 3 in the flash memory 3. The counter value of the timeout monitoring circuit 6 thus becomes “05”.

At T27, the controller 2 outputs a write enable signal 9 and a data signal 11 to the flash memory 3. At the same time, the controller 2 issues address signals 10 (address (0) 100 to address (3) 103)=4(HEX). Because the value of the address identification flag 5a is “1”, the address inversion circuit 4 outputs input address signals 10a (address (0) 104 to address (3) 107)=4(HEX) to the flash memory 3. Consequently, the controller 2 writes the data M4 indicated by the data signal 11 in the address 4 in the flash memory 3. The counter value of the timeout monitoring circuit 6 thus becomes “06”.

At T28, the controller 2 outputs a write enable signal 9 and a data signal 11 to the flash memory 3. At the same time, the controller 2 issues address signals 10 (address (0) 100 to address (3) 103)=5(HEX). Because the value of the address identification flag 5a is “1”, the address inversion circuit 4 outputs input address signals 10a (address (0) 104 to address (3) 107)=5(HEX) to the flash memory 3. Consequently, the controller 2 writes the data M5 indicated by the data signal 11 in the address 5 in the flash memory 3. The counter value of the timeout monitoring circuit 6 thus becomes “07”.

At T29, the controller 2 outputs a write enable signal 9 and a data signal 11 to the flash memory 3. At the same time, the controller 2 issues address signals 10 (address (0) 100 to address (3) 103)=6(HEX). Because the value of the address identification flag 5a is “1”, the address inversion circuit 4 outputs input address signals 10a (address (0) 104 to address (3) 107)=6(HEX) to the flash memory 3. Consequently, the controller 2 writes the data M6 indicated by the data signal 11 in the address 6 in the flash memory 3. The counter value of the timeout monitoring circuit 6 thus becomes “08”.

At T30, the controller 2 outputs a write enable signal 9 and a data signal 11 to the flash memory 3. At the same time, the controller 2 issues address signals 10 (address (0) 100 to address (3) 103)=7(HEX). Because the value of the address identification flag 5a is “1”, the address inversion circuit 4 outputs input address signals 10a (address (0) 104 to address (3) 107)=7(HEX) to the flash memory 3. Consequently, the controller 2 writes the data M7 indicated by the data signal 11 in the address 7 in the flash memory 3. The counter value of the timeout monitoring circuit 6 thus becomes “09”.

At T31, the controller 2 outputs a write enable signal 9 and a data signal 11 to the flash memory 3. At the same time, the controller 2 issues address signals 10 (address (0) 100 to address (3) 103)=8(HEX). Because the value of the address identification flag 5a is “1”, the address inversion circuit 4 outputs input address signals 10a (address (0) 104 to address (3) 107)=8(HEX) to the flash memory 3. Consequently, the controller 2 writes the data MS indicated by the data signal 11 in the address 8 in the flash memory 3. The counter value of the timeout monitoring circuit 6 thus becomes “0A”.

At T32, the controller 2 outputs a write enable signal 9 and a data signal 11 to the flash memory 3. At the same time, the controller 2 issues address signals 10 (address (0) 100 to address (3) 103)=9(HEX). Because the value of the address identification flag 5a is “1”, the address inversion circuit 4 outputs input address signals 10a (address (0) 104 to address (3) 107)=9(HEX) to the flash memory 3. Consequently, the controller 2 writes the data M9 indicated by the data signal 11 in the address 9 in the flash memory 3. The counter value of the timeout monitoring circuit 6 thus becomes “0B”.

At T33, the controller 2 outputs a write enable signal 9 and a data signal 11 to the flash memory 3. At the same time, the controller 2 issues address signals 10 (address (0) 100 to address (3) 103)=A(HEX). Because the value of the address identification flag 5a is “1”, the address inversion circuit 4 outputs input address signals 10a (address (0) 104 to address (3) 107)=A(HEX) to the flash memory 3. Consequently, the controller 2 writes the data MA indicated by the data signal 11 in the address A in the flash memory 3. The counter value of the timeout monitoring circuit 6 thus becomes “0C”.

At T34, the controller 2 outputs a write enable signal 9 and a data signal 11 to the flash memory 3. At the same time, the controller 2 issues address signals 10 (address (0) 100 to address (3) 103)=B(HEX). Because the value of the address identification flag 5a is “1”, the address inversion circuit 4 outputs input address signals 10a (address (0) 104 to address (3) 107=B(HEX) to the flash memory 3. Consequently, the controller 2 writes the data MB indicated by the data signal 11 in the address B in the flash memory 3. The counter value of the timeout monitoring circuit 6 thus becomes “0D”.

At T35, the controller 2 outputs a write enable signal 9 and a data signal 11 to the flash memory 3. At the same time, the controller 2 issues address signals 10 (address (0) 100 to address (3) 103)=C(HEX). Because the value of the address identification flag 5a is “1”, the address inversion circuit 4 outputs input address signals 10a (address (0) 104 to address (3) 107)=C(HEX) to the flash memory 3. Consequently, the controller 2 writes the data MC indicated by the data signal 11 in the address C in the flash memory 3. The counter value of the timeout monitoring circuit 6 thus becomes “0E”.

At T36, the controller 2 outputs a write enable signal 9 and a data signal 11 to the flash memory 3. At the same time, the controller 2 issues address signals 10 (address (0) 100 to address (3) 103)=D(HEX). Because the value of the address identification flag 5a is “1”, the address inversion circuit 4 outputs input address signals 10a (address (0) 104 to address (3) 107)=D(HEX) to the flash memory 3. Consequently, the controller 2 writes the data MD indicated by the data signal 11 in the address D in the flash memory 3. The counter value of the timeout monitoring circuit 6 thus becomes “0F”.

At T37, the controller 2 outputs a write enable signal 9 and a data signal 11 to the flash memory 3. At the same time, the controller 2 issues address signals 10 (address (0) 100 to address (3) 103)=E(HEX). Because the value of the address identification flag 5a is “1”, the address inversion circuit 4 outputs input address signals 10a (address (C) 104 to address (3) 107)=E(HEX) to the flash memory 3. Consequently, the controller 2 writes the data ME indicated by the data signal 11 in the address E in the flash memory 3. The counter value of the timeout monitoring circuit 6 thus becomes “10”.

At T38, the controller 2 outputs a write enable signal 9 and a data signal 11 to the flash memory 3. At the same time, the controller 2 issues address signals 10 (address (0) 100 to address (3) 103)=F(HEX). Because the value of the address identification flag 5a is “1”, the address inversion circuit 4 outputs input address signals 10a (address (0) 104 to address (3) 107)=F(HEX) to the flash memory 3. Consequently, the controller 2 writes the data MF indicated by the data signal 11 in the address F in the flash memory 3. The counter value of the timeout monitoring circuit 6 thus becomes “11”. Writing of all data is thus completed (step S25).

Upon completion of the writing, the controller 2 issues a set command to the address identification flag circuit 5. The controller 2 then issues a reset command to the updating flag circuit 15. Then, the controller 2 issues a reset command to the timeout monitoring circuit 6.

At T39, the value of the address identification flag 5a is reset to “0” (step S27). Then, the value of the updating flag 15a is reset to “0” (step S28). The value of the timeout monitoring circuit 6 is reset to “00”. And because the controller 2 is also reset (self-reset) and the value of the updating flag 15a is “0”, the controller 2 reads the main program of the new firmware and starts an ordinary processing.

According to the present invention, therefore, it is possible to leave one or more valid boot loaders in a flash memory by writing a new boot loader in an area that is different from that of an existing boot loader when a boot loader is to be updated in the flash memory. Consequently, even when a trouble occurs during firmware updating, a valid boot loader can be used to execute the firmware updating again regardless of the trouble occurrence timing.

According to the present invention, it is possible to realize a firmware updating circuit of the present invention just by adding a simple gate IC, which is not so expensive like LSI, etc. Consequently, the reliability of the firmware in the flash memory is improved. Although the reliability of the firmware updating is realized with duplication of a flash memory in general, the present invention realizes such reliability with less hardware items as described above, thereby the high reliability is realized with a low manufacturing cost.

According to the present invention, a timeout monitoring circuit is provided. This monitoring circuit makes it possible to determine success or failure of firmware updating automatically. Consequently, no hand is required to determine whether or not the subject firmware updating is ended normally, that is, the determination is made automatically.

According to the present invention, the firmware designer can design firmware without being conscious of the size of the boot loader. Generally, in case where a boot loader occupies a large fixed area in a flash memory, the firmware is unavoidably restricted in designing. In the case of the present invention, however, the sizes of the boot loader and the main program can be changed upon each revision-up of firmware. Thus the firmware designer can design firmware freely without giving any consideration to the size of the firmware. Furthermore, the firmware designer is not required to be conscious of address inversion at all.

According to the present invention, a plurality of areas are assumed for storing a boot loader temporarily at the time of firmware updating. However, the plurality of areas are united into one when the firmware updating is ended. Consequently, the area for storing the boot loader never suppress the area for storing the main program. Furthermore, no external switch is used to change areas at the time of firmware updating. Thus the system operator can execute the firmware updating without regard to success/failure of the operation.

According to the present invention, a valid boot loader can remain at least in one of the top (address) and the bottom (address) of a non-volatile memory using addresses inverted from those in the ordinary firmware operation at the time of firmware updating. And the valid boot loader can be used to execute firmware updating again. Furthermore, after the firmware updating, the firmware operation can be made just as before in the normal state.

According to the present invention, no sequence is required, for example, for saving a boot loader. A simple hardware circuit is just added to realize rewriting. In this case, the rewriter (e.g., processor) requires no intelligence.

In the above embodiment, the address inversion circuit 4 is realized with an AND circuit and OR circuits. However, the circuit 4 may be realized with an integrated circuit such as a PLD (Programmable Logic Device). If the power supply of this PLD is shared by the flash memory 3 and the controller 2, all of the counter of the timeout monitoring circuit 6, the address identification flag circuit 5, and the updating flag circuit 15 can be integrated in the PLD.

In such a case, the number of parts can be reduced compared to when each of the address inversion circuit 4, the timeout monitoring circuit 6, the address identification flag circuit 5, and the updating flag circuit 15 is realized with a combination of logic gate ICs, thereby the failure rate is lowered and the reliability is improved.

The present invention can apply to a computer device (information processing apparatus) in which firmware is mounted like, for example, a server unit. Particularly, it is preferred to apply the present invention to a blade server unit provided with a large absolute number of servers and required to execute many firmware updating processings. Besides those servers, the present invention can also apply to any of information processing apparatuses that store firmware in a non-volatile memory and provided with functions to connect an external device so as to update the firmware respectively.

What is claimed is:

1. A firmware updating circuit, comprising:
an identification part for storing identification data corresponding to an address of a boot loader in a non-volatile memory for storing the boot loader and a main program; and
an address inversion part for changing an address for reading the loader, output from a controller to the non-volatile memory, and an address for writing a boot loader to be updated according to the identification data respectively so that those addresses come to be different from each other and at least one of the boot loader and the boot loader to be updated exists in the non-volatile memory when the controller updates both the boot loader and the main program.

2. The circuit according to claim 1,
wherein the address inversion part executes either inversion or non-inversion for the address for reading according to the identification data, then executes the other for the address for writing.

3. The circuit according to claim 2,
wherein the address inversion part executes non-inversion for the address for reading and inversion for the address for writing when the identification data is in a first state.

4. The circuit according to claim 2,
wherein the address inversion part executes inversion for the address for reading and inversion for the address for writing when the identification data is in a second state.

5. The circuit according to claim 1, further comprising a monitoring part for monitoring an updating related timeout at the time of updating,
wherein the identification part, when the monitoring part detects a timeout, updates the identification data, and
wherein the address inversion part executes inversion and non-inversion for the address for reading and the address for writing according to the updated identification data.

6. An information processing apparatus, comprising:
a controller;
a non-volatile memory for storing a boot loader and a main program; and
the firmware updating circuit according to any of claims 1 to 5 and connected to the controller and the non-volatile memory communicably.

7. A firmware updating method, comprising the steps of:
(a) changing or not changing an address for reading the boot loader, output from the controller, according to identification data corresponding to an address of the boot loader in the non-volatile memory so that at least one of the boot loader and another boot loader to be updated comes to exist in the non-volatile memory when a controller updates a boot loader and a main program stored in the non-volatile memory, then sending a result of the change/not change operation to the non-volatile memory; and
(b) executing the other of the change/not-change operation for an address for writing the boot loader to be updated, output from the controller, according to the identification data, then sending a result of the operation to the non-volatile memory.

8. The method according to claim 7,
wherein the step (a) includes a step of:
(a1) executing either inversion or non-inversion for the address for reading according to the identification data; and
wherein the step (b) includes a step of:
(b1) executing the other of the inversion and non-inversion for the address for writing according to the identification data at the time of the updating.

9. The method according to claim 8,
wherein the step (a1) includes a step of:
(a11) executing non-inversion for the address for reading when the identification data is in the first state; and
wherein the step (b1) includes a step of:
(b11) executing inversion for the address for writing when the identification data is in the first state.

10. The method according to claim 8,
wherein the step (a1) includes a step of:
(a12) executing inversion for the address for reading when the identification data is in the second state; and
wherein the step (b1) includes a step of:
(b12) executing non-inversion for the address for writing when the identification data is in the second state.

11. The method according to claim 7, further comprising the steps of:
(c) monitoring an updating related timeout at the time of the updating;
(d) updating the identification data when the timeout is detected; and
(e) executing the steps (a) and (b) according to the updated identification data.
